(19) United States
(12) Patent Application Publication
(10) Pub. No.: US 2017/0202213 A1
(43) Pub. Date: Jul. 20, 2017

(54) RESERVOIR FOR STORING PRODUCTS AT CRYOGENIC TEMPERATURES

(71) Applicant: CRYOPAL, Bussy-Saint-Georges (FR)

(72) Inventors: Sébastien GADREY, Gouloux (FR); Wilfried LEGERON, Joinville le Pont (FR); Romain BAHILLO, Marne la Valle (FR)

(21) Appl. No.: 15/408,850

(22) Filed: Jan. 18, 2017

(30) Foreign Application Priority Data
Jan. 18, 2016 (FR) 1650367

(51) Int. Cl. A01N 1/02; G01N 1/42; F25D 3/10

(52) U.S. Cl. CPC A01N 1/0252; F25D 3/105; G01N 1/42

(57) ABSTRACT

A reservoir for storing products at cryogenic temperatures is provided. The reservoir includes an insulated vacuum tank delimiting a storage volume having an open upper end. The reservoir includes a mobile lid for closing and opening the storage volume. The reservoir also includes a controlled actuating member mechanically connected to the lid in order to move the lid. The actuating member being able to move between a first position that places the lid in its position for closing the storage volume of the tank and a second position that places the lid in a position for opening the storage volume of the tank.

### CROSS REFERENCE TO RELATED APPLICATIONS

This application claims priority to French Patent Application No. 1650367 filed Jan. 18, 2016, the entire contents of which are incorporated herein by reference.

### BACKGROUND

The invention relates to a reservoir for storing products at cryogenic temperatures.

### SUMMARY

The invention relates more particularly to a reservoir for storing products at cryogenic temperatures, comprising an insulated vacuum tank delimiting a storage volume having an open upper end, the reservoir comprising a mobile lid for closing and opening the storage volume.

The invention relates in particular to reservoirs for the storage of products (for example cryo-biological products). These insulated vacuum reservoirs generally contain a volume of gas (nitrogen or the like) in liquid and/or gaseous form in order to keep the products at determined low temperatures (generally from −200° C. to −80° C. depending on the application). Reference may, for example, be made to documents WO98/58215A or WO96/26402A.

There are numerous cryogenic devices or containers in existence, notably for preserving biological samples. These devices comprise a lid for accessing the storage volume (for example via a suitable hatch). The samples are introduced into the tank for example by means of a storage device (rack(s), case(s), etc.). The term “rack” used here is intended to denote all possible equivalent configurations of storage device.

The operators take on the role of inserting, removing, using, etc. the racks containing the samples that are to be preserved. Such handling operations which once were rare are becoming increasingly frequent and repetitive. This leads to an additional burden of manual work and of traceability management.

It is an object of the present invention to alleviate all or some of the abovementioned disadvantages of the prior art.

To this end, the reservoir according to the invention which in other respects is in accordance with the generic definition given thereof in the above preamble is essentially characterized in that it comprises a controlled actuating member mechanically connected to the lid in order to move the lid, the actuating member being able to move between a first position that places the lid in its position for closing the storage volume of the tank and a second position that places the lid in a position for opening the storage volume of the tank.

The reservoir makes it possible for at least some of the process of handling cryogenic samples to be automated and made safer. The reservoir notably allows the opening/closing of the reservoir to be automated, quickly, without impeding the sample handling cycles. This is particularly advantageous when the reservoir is built into a room containing several reservoirs of this type.

This automating of the openings/closings means that these operations can be performed in parallel time, which means to say advantageously while handling operations are being performed on other containers.

In addition, the reservoir allows opening to be performed preventatively, namely before a given time of use.

If need be, the opening/closing operations may be remote controlled (wirelessly or over a wired connection).

Independently of the presence of a controlled actuating member for performing automatic openings/closings, the invention may relate to a reservoir for storing products at cryogenic temperatures, comprising an insulated vacuum tank delimiting a storage volume having an open upper end, the reservoir comprising a mobile lid for closing and opening the storage volume, in which the reservoir comprises a support basket arranged in the storage volume of the tank, the support basket comprising a rigid body delimiting a plurality of compartments intended to accommodate elements such as product storage racks, the compartments being delimited by lateral walls and being open at their upper end that coincides with the open end of the storage volume.

Moreover, embodiments of the invention may comprise one or more of the following features:
the actuating member comprises a first end connected to the tank and a second end connected to the lid,
the actuating member comprises at least one of the following: a telescopic mechanism, a geared mechanism, an actuating cylinder,
the actuating member comprises a hydraulically and/or pneumatically and/or electrically driven drive element,
the reservoir comprises a sensor(s) system for measuring the position of the actuating member,
the reservoir comprises at least one detection sensor configured to detect when the actuating member reaches its first position and/or its second position,
the reservoir comprises a support basket arranged in the storage volume of the tank, the support basket comprising a rigid body delimiting a plurality of compartments intended to accommodate elements such as product storage racks, the compartments being delimited by lateral walls and being open at an upper end that coincides with the open end of the storage volume of the tank,
the support basket is fixed inside the tank via fixing members notably at least one screw-nut system,
the upper end of the support basket comprises at least one fixing member intended to collaborate with a device for positioning or guiding the elements intended to be stored in the compartment or compartments,
the lower end of the support basket is at least partially closed and is situated above the bottom of the storage volume of the tank,
the support basket is made of a material that has a thermal conductivity of between 200 W/m·K and 400 W/m·K,
the support basket is made of aluminum.

The invention may also relate to any alternative device or method comprising any combination of the features listed hereinabove or hereinbelow.

### BRIEF DESCRIPTION OF THE DRAWINGS

Other particulars and advantages will become apparent from reading the description hereinafter, which is given with reference to the figures in which:

FIG. 1 depicts a schematic and partial perspective view illustrating one example of a cryogenic reservoir according to one exemplary embodiment of the invention, with its lid in the open position,

FIG. 2 depicts a view similar to that of FIG. 1 in which the lid is in the closed position,

FIG. 3 depicts a schematic and partial perspective view from above, illustrating one example of a support basket that can be used in a cryogenic reservoir,

FIG. 4 depicts a schematic and partial side view illustrating how a support basket according to FIG. 3 is incorporated into a reservoir,

FIG. 5 depicts a schematic and partial perspective side view illustrating one example of a sample support rack that can be stored in such a reservoir.

### DESCRIPTION OF PREFERRED EMBODIMENTS

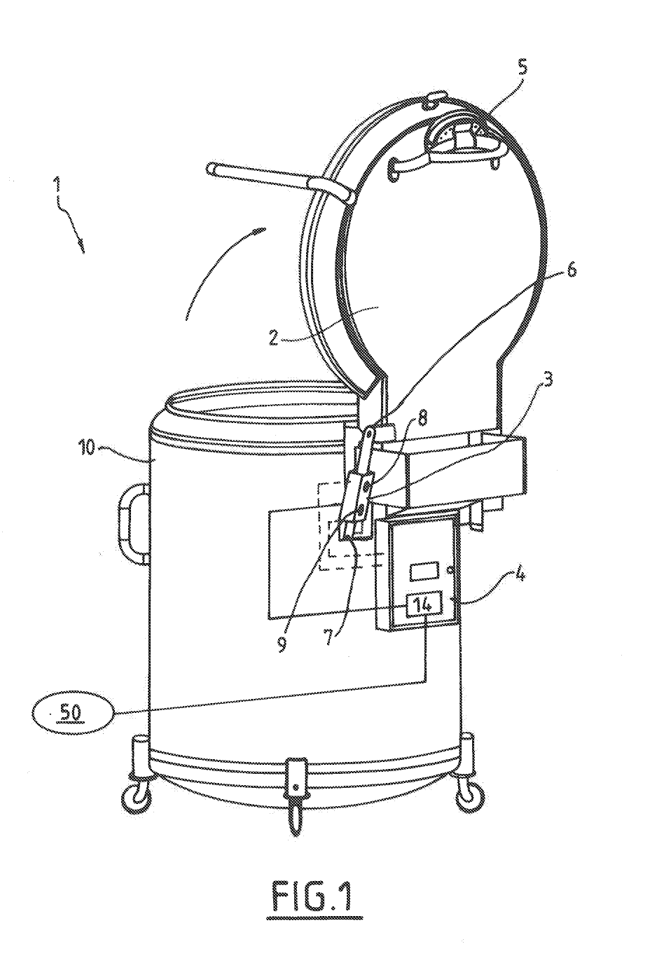

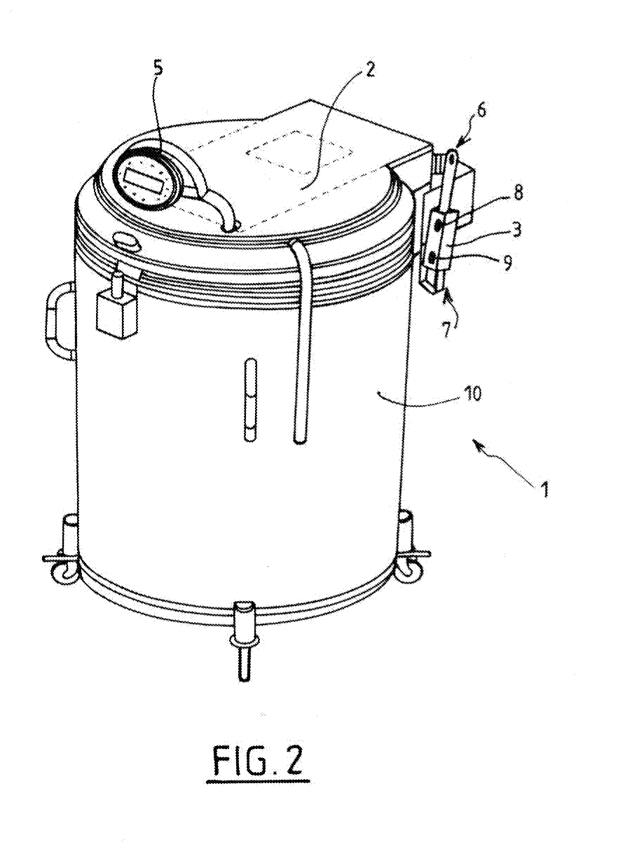

The reservoir 1 for storing products at cryogenic temperatures and depicted in FIGS. 1 and 2 in the conventional way comprises an insulated vacuum double-walled tank 10 delimiting a storage volume having an open upper end. The reservoir 1 comprises a lid 2 able to move for closing and opening the storage volume.

In this embodiment, the lid 2 is able to move in rotation. The lid 2 is, for example, rotationally mobile at one of its ends about an axis of rotation situated for example in a plane parallel to the plane of the upper opening of the tank 10. For example, the lid 2 is pivot-mounted on an axle secured to an exterior wall of the tank 10 (near the upper end of the tank 10).

Of course, as an alternative, the lid 2 may be mobile translationally or in a combination of rotational and translational movement(s).

According to an advantageous particular feature, the reservoir 1 comprises a controlled actuating member 3 mechanically connected to the lid 2 so as to move the lid 2. The actuating member 3 is able to move between a first position that places the lid 2 in its position for closing the storage volume of the tank 10 (FIG. 2) and a second position that places the lid in a position for opening the storage volume of the tank 10 (FIG. 1).

The actuating member 3 for example comprises a first end 7 rigidly connected to the tank 10 and a second end 6 rigidly connected to the lid 2.

The actuating member 3 for example comprises at least one of the following: a telescopic mechanism, a geared mechanism, an actuating cylinder. The actuating member 3 comprises a hydraulically and/or pneumatically and/or electrically driven drive element for movement between the two positions. The motor for example achieves the rotary and/or linear drive that allows the relative movement of the said ends. This structure thus allows the said ends to be moved closer together/further apart in order to close/open the lid 2 automatically.

The actuating member 3 may be controlled by an electronic man-machine interface 5 which may be the same as the one used to drive the temperature regulation or some other operating parameter of the reservoir 1 (for example the level of cooling gas or liquid) cf. FIG. 2.

Of course, the control of the movement of the lid 2 may equally be had remotely (using a wireless or wired connection).

For example, a control interface 5 may be configured to receive an external command transmitted to the actuating member 3 (cf. FIG. 1).

In the example of FIGS. 1 and 2 the actuating member 3 is a pneumatic actuating cylinder.

According to one possible operating example, a command from the operator or from a machine via the interface (5 and/or 50) for example actuates an energy distributor 14 (in this example a flow of gas, but could be a flow of liquid or an electrical current).

Under the effect of the fluid pressure, the actuating cylinder 3 causes the ends 6, 7 to move closer together or further apart. The actuating cylinder 3 (or equivalent) is, for example, driven by an electropneumatic control system allowing a small electrical power to control the pneumatic distributor at a high enough frequency of use (notably from 0 to 10 Hz and preferably 0.03 Hz).

The device preferably comprises a system of sensor(s) 8, 9 for measuring the position of the actuating member 3. For example, the reservoir 1 comprises at least one detection sensor 8, 9 configured to detect when the actuating member 3 reaches its first position and/or its second position. The position sensors 8, 9 are, for example, Hall-effect sensors positioned in a determined manner on the member 3 and corresponding to the lid 2 positions that are to be detected (open/closed).

The end 6 of the actuating cylinder arm may be connected to the lid 2 for example via a mounting plate (for example made of stainless steel grade 304L).

Information regarding the status (position of the lid 2) may be sent to control electronics 4 (following detection of the position by the sensor or sensors 7, 8). The control electronics 4 may comprise or be connected to the man-machine interface 5, 50.

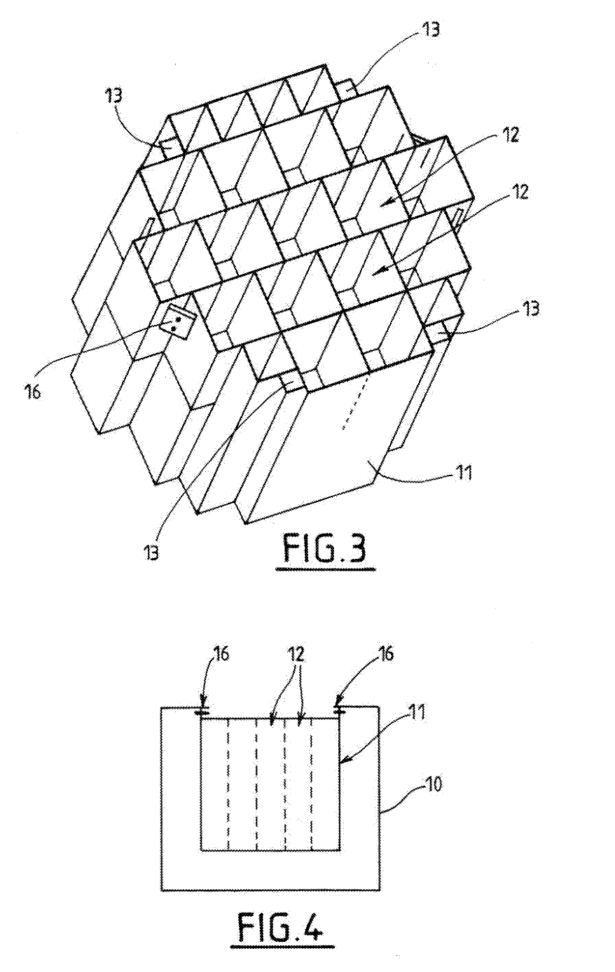

FIG. 3 depicts one example of a support basket 11 that can be used in such a reservoir 1 (or in any type of reservoir with or without controlled actuating member 3).

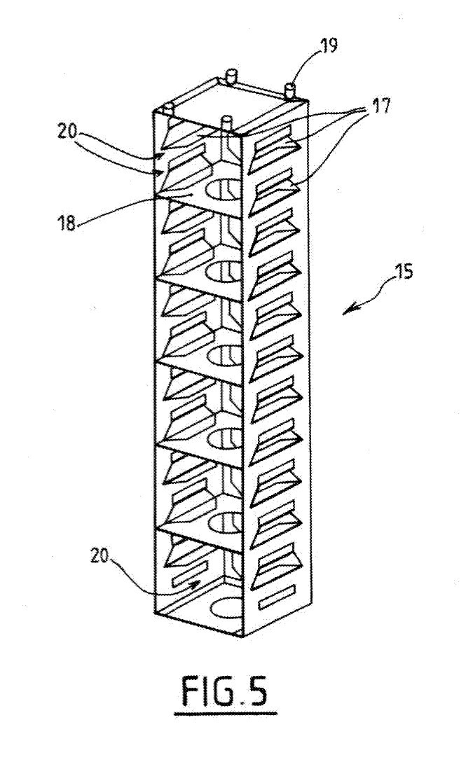

The basket 11 is designed to accommodate objects, for example stored in storage racks 15 or towers with multiple spaces 20 (like the one illustrated in FIG. 5). The support basket 11 comprises a rigid body delimiting a plurality of compartments 12 or cells intended to accommodate elements such as product storage racks 15. The compartments 12 are delimited by lateral walls and possibly by bottom walls and are open at an upper end which coincides with the open end of the storage volume of the tank 10.

The support basket 11 may be fixed inside the tank 10 via fixing members 16 notably by means of a screw and nut system. For example, the upper end of the support basket 11 comprises at least one fixing member 16 intended to collaborate with a device for positioning or guiding the elements intended to be stored in the compartment or compartments.

The basket 11 is for example fixed inside the tank 10 via a system of four screws/nuts situated diametrically opposite each other. A system of plates 13 can be used to fix to the upper end of the basket 11 a system for positioning the racks 15. The basket 11 may for example comprise an indexing or referencing system that allows the racks to be positioned and removed precisely (particularly in the case of an automatic installation).

The position of the basket 11 in the tank 10 may be fixed and the angle of positioning with respect to the central vertical axis of the tank 10 may be determined or modified according to the way the samples in the tank 10 are accessed.

For preference, the lower end of the support basket 11 is at least partially closed and situated above the bottom of the storage volume of the tank 10 (cf. FIG. 4).

The basket 11 allows the racks 15 (shelving units holding the samples) to be surrounded and allows the temperature within the tank 10 to be distributed.

The racks 15 may for example contain boxes containing biological samples in tubes/straws/bags.

The racks 15 are intended to facilitate handling. The basket 11 guides the racks 15 (movement in vertical translation). Advantageously there may thus be just one direction in which the racks are extracted and inserted. For preference, the device has no additional rack immobilization system. The racks 15 may rest on the bottom of the basket 11.

The racks 15 are preferably rigid and structured to be able to withstand the accelerations caused by an automated handling system (rate of travel of 0 to 2 m/s and preferably 0.3 m/s for example) while at the same time maintaining a relatively uniform geometry.

The racks 15 may be made from stainless steel plates (notably gauge 304L) by cutting, bending and assembling (welding) in order to obtain a geometry defining housings 20 (for example twelve housings). As may be seen in FIG. 5, the racks 15 may be equipped with horizontal stiffening plates 18 provided every two housings 20.

Each rack 15 may be equipped with spring leaves 17 cut from the mass of the lateral walls of the rack 15 and positioned around the boxes housed in the housings 20. These bent leaves project into the housing 20 to hold the boxes of samples in a stable position as a result of the elastic deformation of the leaves 17. The bent leaves 17 (elastic shapes) therefore allow the boxes to be immobilized in the housings 20 delimited in the rack 15. Upper screws or studs 19 may be provided at the end of the rack 15 to allow the attachment of an accessory or interface.

For preference, the support basket 11 is made of a material that has a thermal conductivity of, for example, between 200 W/m·K and 400 W/m·K.

For example, the basket 11 is made of “series 1000” aluminum (which means to say close to pure aluminum) and has a thermal conductivity which is twice that (at 200 W×m−1×K−1) of other materials commonly used in mechanical assembly and in cryogenic containers. Materials of greater conductivity exist (for example gold, silver or copper) but the associated additional cost does not justify the associated thermal gains.

In addition, the structure of the basket 11 makes it possible to even out the circulation of the cold fluid around the basket. The basket 11 makes it possible to ensure a uniform temperature at the racks 15 and therefore the samples contained in the racks 15.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A reservoir for storing products at cryogenic temperatures, comprising an insulated vacuum tank delimiting a storage volume having an open upper end, the reservoir comprising a mobile lid for closing and opening the storage volume, wherein a controlled actuating member selected from the group consisting of hydraulically, pneumatically, and electrically driven drive element and mechanically connected to the lid in order to move the lid, the actuating member being able to move between a first position that places the lid in a position for closing the storage volume of the tank and a second position that places the lid in a position for opening the storage volume of the tank.

2. The reservoir of claim 1, wherein the actuating member comprises a first end connected to the tank and a second end connected to the lid.

3. The reservoir of claim 1, wherein the actuating member comprises at least one of the following: a telescopic mechanism, a geared mechanism, or an actuating cylinder.

4. The reservoir of claim 1, further comprising a sensor system for measuring the position of the actuating member.

5. The reservoir of claim 4, further comprising at least one detection sensor configured to detect when the actuating member reaches the first position and/or the second position.

6. The reservoir of claim 1, further comprising a support basket arranged in the storage volume of the tank, the support basket comprising a rigid body delimiting a plurality of compartments intended to accommodate elements such as product storage racks, the compartments being delimited by lateral walls and being open at an upper end that coincides with the open end of the storage volume of the tank.

7. The reservoir of claim 6, wherein the support basket is fixed inside the tank via fixing members.

8. The reservoir of claim 6, wherein the upper end of the support basket comprises at least one fixing member intended to collaborate with a device for positioning or guiding the elements intended to be stored in the compartment or compartments.

9. The reservoir of claim 6, wherein the lower end of the support basket is at least partially closed and is situated above the bottom of the storage volume of the tank.

10. The reservoir of claim 6, wherein the support basket is made of a material that has a thermal conductivity of between 200 W/m·K and 400 W/m·K.

11. The reservoir of claim 6, wherein the support basket is made of aluminum.
